(19) United States
(12) Patent Application Publication
(10) Pub. No.: US 2016/0275447 A1
(43) Pub. Date: Sep. 22, 2016

(54) USER INTERFACE FOR FACILITATING ENFORCEMENT OF SHIPPING RULES

(71) Applicant: United Parcel Service of America, Inc., Atlanta, GA (US)

(72) Inventors: David Allison Bennett, Bothell, WA (US); Lynn Shaindell Goldhaber, Bellevue, WA (US); Christopher Michael Monsos, Seattle, WA (US)

(21) Appl. No.: 14/931,218

(22) Filed: Nov. 3, 2015

Related U.S. Application Data
(60) Provisional application No. 62/135,491, filed on Mar. 19, 2015.
(60) Provisional application No. 62/135,496, filed on Mar. 19, 2015.

(51) Int. Cl. G06Q 10/08; G06F 3/0484; G06F 3/0482; G06F 17/24; G06Q 10/06; G06F 17/30

(52) U.S. Cl. CPC G06Q 10/0832; G06Q 10/06316; G06F 17/30386; G06F 3/0482; G06F 17/24; G06F 3/0484

(57) ABSTRACT

Methods, systems, and apparatus, including computer programs encoded on a computer storage medium, for a user interface for facilitating enforcement of shipping rules. In one aspect, a method includes receiving one or more keywords via a first user interface element descriptive of a good to be shipped, determining whether at least a portion of at least one of the one or more keywords matches at least a portion of a corresponding keyword in a keyword list, responsive to determining that at least a portion of the at least one of the one or more keywords matches at least a portion of a corresponding keyword in the keyword list, identifying an action to be taken for the at least one of the one or more keywords, and providing a second user interface element within the user interface, the second user interface element being associated with the action to be taken.

### CROSS-REFERENCE TO RELATED APPLICATIONS

This application claims priority to U.S. Provisional Application No. 62/135,496 filed Mar. 19, 2015, which is hereby incorporated herein in its entirety by reference.

### BACKGROUND

Carriers, such as UPS, handle millions of deliveries on daily basis. Carriers typically arrange delivery of packages or mail between a consignor or a shipper and a consignee or a recipient. The carrier is responsible for enforcing different rules on different packages. Different types of packages often require a specific type of handling or that certain actions be taken prior to or during the shipping of such packages. For example, certain packages may require delicate handling during shipping. Other packages may not be allowed for shipping by the specific carrier.

Furthermore, applicable laws, rules, and regulations may prohibit the transportation of hazardous goods/items by carriers. To comply with such laws, rules, and regulations, the carrier must block the shipping of such items. Further, large multi-national vendors naturally require enforcement of many (e.g., thousands of rules) different rules simultaneously. These rules are typically enforced based on information provided to the carrier by the consignor/shipper. Management and enforcement of such rules can prove cumbersome and require vast manpower resources. Therefore, there is a strong need in the industry for a system that can automatically facilitate processing and enforcement of such rules.

### BRIEF SUMMARY

In general, one innovative aspect of the subject matter described herein can be embodied in methods that include the actions of displaying a shipping user interface for completing a shipping initiation process comprising a first user interface element for receiving a textual description of goods/items to be shipped, receiving, one or more text keywords provided by a first user using the first user interface element, the one or more text keywords being keywords descriptive of goods/items within a package to be shipped, the package being a package of a second user; determining that at least a portion of the text keywords matches a corresponding keyword in a keyword list; responsive to determining that at least a portion of the at least one of the one or more keywords matches at least a portion of a corresponding keyword in the keyword list, identifying an action to be taken for the at least one of the one or more keywords; responsive to identifying the action to be taken for the at least one of the one or more keywords, providing a second user interface element within the user interface, the second user interface element being associated with the action to be taken, providing a second user interface element within the user interface, the second user interface element comprising a text message for display, wherein the second user interface element is configured to perform different actions in response to user interaction.

Other embodiments of this aspect include corresponding systems, apparatus, and computer programs, configured to perform the actions of the methods encoded on computer storage devices.

These and other embodiments can each may optionally include one or more of the following features. Accessing, from the data store, one or more lists of keywords, each list being associated with at least one action. Receiving a user interaction with the displayed second user interface element and in response terminating the shipping initiation process. Displaying a text message comprising an indication that the package includes at least one good/item that requires one or more actions be performed on the good/item in order for the good/item to be deemed allowable for shipping and identifying one or more goods/items in the package as belonging to a second list of items, the second list of goods/items being goods/items that are not allowed for shipping unless one or more actions required are performed. Receiving a user interaction with the displayed second user interface element, indicating that the one or more actions required have not been performed and in response terminate the shipping initiation process. Receiving a user interaction, with the displayed second user interface element, indicating that the one or more actions required have been performed and in response complete the shipping initiation process allowing the package to be shipped.

In general, another aspect of the subject matter described herein can be embodied in methods that include the actions displaying a shipping user interface for completing a shipping initiation process comprising a first user interface element for receiving a textual description of goods/items to be shipped, receiving, one or more text keywords provided by a first user using the first user interface element, the one or more text keywords being keywords descriptive of goods/items within a package to be shipped, the package being a package of a second user, determining that each of the text keywords do not match any keywords in a keyword list, in response to determining that each of the text keywords do not match any keywords in the keyword list, providing a second user interface element within the user interface, the second user interface element comprising a text message for display, the text message comprising instructions for the first user to complete one or more actions before shipping the package.

Other embodiments of this aspect include corresponding systems, apparatus, and computer programs, configured to perform the actions of the methods, encoded on computer storage devices.

Particular embodiments of the subject matter described herein can be implemented so as to realize one or more of the following advantages. Facilitating more efficient enforcement of shipping rules. The invention provides means for faster processing of shipping information, reducing the wait time associated with shipping packages and improving the overall user experience. Similarly, multi-step guidance is provided to interface operators, reducing chance for erroneous shipping or shipping that is not in compliance with current rules and regulations.

The details of one or more embodiments of the subject matter described herein are set forth in the accompanying drawings and the description below. Other features, aspects, and advantages of the subject matter will become apparent from the description, the drawings, and the claims.

### BRIEF DESCRIPTION OF THE DRAWINGS

Having thus described the invention in general terms, reference will now be made to the accompanying drawings, which are not necessarily drawn to scale, and wherein:

FIG. 1 is an overview of a system that can be used to practice embodiments of the present invention;

FIG. 2 is an exemplary schematic diagram of a carrier computing entity according to one embodiment of the present invention;

FIG. 3 is an exemplary schematic diagram of a user computing entity according to one embodiment of the present invention;

FIGS. 7, 8, 10, 12 and 14 are flow charts illustrating various procedures and operations that may be completed in accordance with various embodiments of the present invention; and

FIGS. 4, 5, 6, 9A, 9B, 11 and 13 illustrate example views of the shipping user interface, in accordance with various embodiments of the present invention.

### DETAILED DESCRIPTION OF VARIOUS EMBODIMENTS

Various embodiments of the present invention now will be described more fully hereinafter with reference to the accompanying drawings, in which some, but not all embodiments of the inventions are shown. Indeed, these inventions may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### I. Computer Program Products, Methods, and Computing Entities

Embodiments of the present invention may be implemented in various ways, including as computer program products that comprise articles of manufacture. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, computer program products, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAM), Thyristor RAM (T-RAM), Zero-capacitor (Z-RAM), Rambus in-line memory module (RIMM), dual in-line memory module (DIMM), single in-line memory module (SIMM), video random access memory (VRAM), cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like. As such, embodiments of the present invention may take the form of an apparatus, system, computing device, computing entity, and/or the like executing instructions stored on a computer-readable storage medium to perform certain steps or operations. Thus, embodiments of the present invention may also take the form of an entirely hardware embodiment, an entirely computer program product embodiment, and/or an embodiment that comprises combination of computer program products and hardware performing certain steps or operations.

Embodiments of the present invention are described below with reference to block diagrams and flowchart illustrations. Thus, it should be understood that each block of the block diagrams and flowchart illustrations may be implemented in the form of a computer program product, an entirely hardware embodiment, a combination of hardware and computer program products, and/or apparatus, systems, computing devices, computing entities, and/or the like carrying out instructions, operations, steps, and similar words used interchangeably (e.g., the executable instructions, instructions for execution, program code, and/or the like) on a computer-readable storage medium for execution. For example, retrieval, loading, and execution of code may be performed sequentially such that one instruction is retrieved, loaded, and executed at a time. In some exemplary embodiments, retrieval, loading, and/or execution may be performed in parallel such that multiple instructions are retrieved, loaded, and/or executed together. Thus, such embodiments can produce specifically-configured machines performing the steps or operations specified in the block diagrams and flowchart illustrations. Accordingly, the block diagrams and flowchart illustrations support various combinations of embodiments for performing the specified instructions, operations, or steps.

### II. Exemplary System Architecture

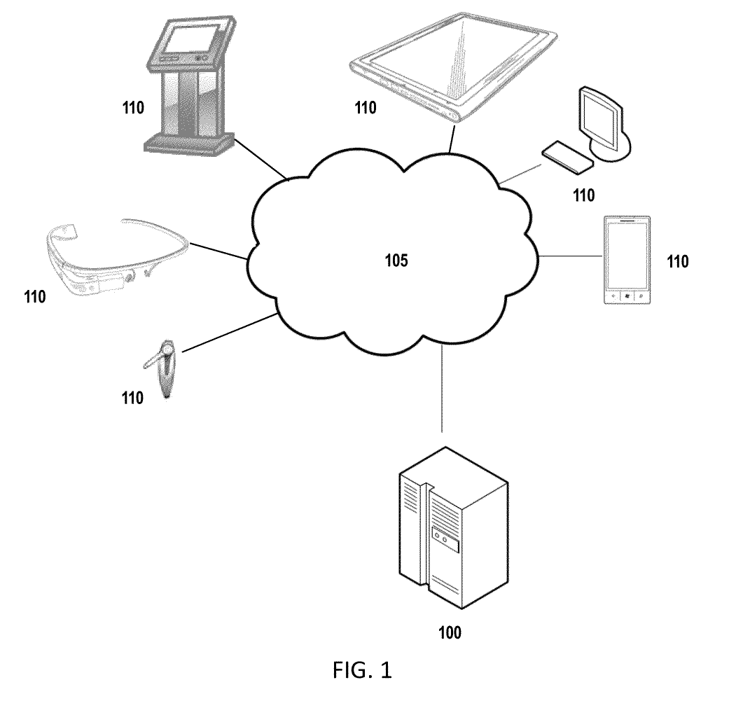

FIG. 1 provides an illustration of an exemplary embodiment of the present invention. As shown in FIG. 1, this particular embodiment may include one or more carrier computing entities 100, one or more networks 105, and one or more user computing entities 110. Each of these components, entities, devices, systems, and similar words used herein interchangeably may be in direct or indirect communication with, for example, one another over the same or different wired or wireless networks. Additionally, while FIG. 1 illustrates the various system entities as separate, standalone entities, the various embodiments are not limited to this particular architecture.

### 1. Exemplary Carrier Computing Entity

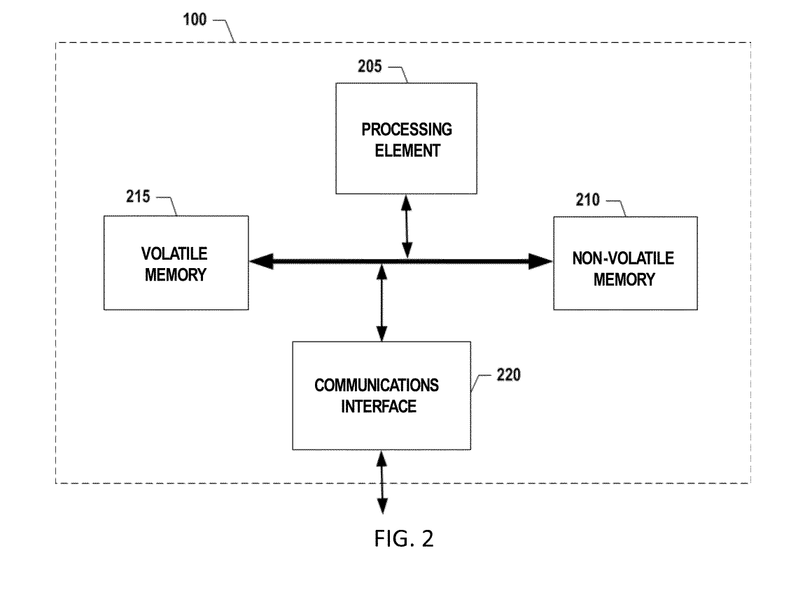

FIG. 2 provides a schematic of a carrier computing entity 100 according to one embodiment of the present invention. A carrier may be a traditional carrier, such as United Parcel Service (UPS), FedEx, DHL, courier services, the United States Postal Service (USPS), Canadian Post, freight companies (e.g. truck-load, less-than-truckload, rail carriers, air carriers, ocean carriers, etc.), and/or the like. However, a carrier may also be a nontraditional carrier, such as Amazon, Google, Uber, ride-sharing services, crowd-sourcing services, retailers, and/or the like. In general, the terms computing entity, computer, entity, device, system, and/or similar words used herein interchangeably may refer to, for example, one or more computers, computing entities, desktop computers, mobile phones, tablets, phablets, notebooks, laptops, distributed systems, gaming consoles (e.g., Xbox, Play Station, Wii), watches, glasses, iBeacons, proximity beacons, key fobs, radio frequency identification (RFID) tags, ear pieces, scanners, televisions, dongles, cameras, wristbands, wearable items/devices, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

As indicated, in one embodiment, the carrier computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. For instance, the carrier computing entity 100 may communicate with user computing entities 110 and/or a variety of other computing entities.

As shown in FIG. 2, in one embodiment, the carrier computing entity 100 may include or be in communication with one or more processing elements 205 (also referred to as processors, processing circuitry, and/or similar terms used herein interchangeably) that communicate with other elements within the carrier computing entity 100 via a bus, for example. As will be understood, the processing element 205 may be embodied in a number of different ways. For example, the processing element 205 may be embodied as one or more complex programmable logic devices (CPLDs), microprocessors, multi-core processors, coprocessing entities, application-specific instruction-set processors (ASIPs), microcontrollers, and/or controllers. Further, the processing element 205 may be embodied as one or more other processing devices or circuitry. The term circuitry may refer to an entirely hardware embodiment or a combination of hardware and computer program products. Thus, the processing element 205 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processing element 205 may be configured for a particular use or configured to execute instructions stored in volatile or non-volatile media or otherwise accessible to the processing element 205. As such, whether configured by hardware or computer program products, or by a combination thereof, the processing element 205 may be capable of performing steps or operations according to embodiments of the present invention when configured accordingly.

In one embodiment, the carrier computing entity 100 may further include or be in communication with non-volatile media (also referred to as non-volatile storage, memory, memory storage, memory circuitry and/or similar terms used herein interchangeably). In one embodiment, the non-volatile storage or memory may include one or more non-volatile storage or memory media 210, including but not limited to hard disks, ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. As will be recognized, the non-volatile storage or memory media may store databases, database instances, database management systems, data, applications, programs, program modules, scripts, source code, object code, byte code, compiled code, interpreted code, machine code, executable instructions, and/or the like. The term database, database instance, database management system, and/or similar terms used herein interchangeably may refer to a collection of records or data that is stored in a computer-readable storage medium using one or more database models, such as a hierarchical database model, network model, relational model, entity-relationship model, object model, document model, semantic model, graph model, and/or the like.

In one embodiment, the carrier computing entity 100 may further include or be in communication with volatile media (also referred to as volatile storage, memory, memory storage, memory circuitry and/or similar terms used herein interchangeably). In one embodiment, the volatile storage or memory may also include one or more volatile storage or memory media 215, including but not limited to RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processing element 205. Thus, the databases, database instances, database management systems, data, applications, programs, program modules, scripts, source code, object code, byte code, compiled code, interpreted code, machine code, executable instructions, and/or the like may be used to control certain aspects of the operation of the carrier computing entity 100 with the assistance of the processing element 205 and operating system.

As indicated, in one embodiment, the carrier computing entity 100 may also include one or more communications interfaces 220 for communicating with various computing entities, such as by communicating data, content, information, and/or similar terms used herein interchangeably that can be transmitted, received, operated on, processed, displayed, stored, and/or the like. Such communication may be executed using a wired data transmission protocol, such as fiber distributed data interface (FDDI), digital subscriber line (DSL), Ethernet, asynchronous transfer mode (ATM), frame relay, data over cable service interface specification (DOC SIS), or any other wired transmission protocol. Similarly, the carrier computing entity 100 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1× (1×RTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), Wi-Fi Direct, 802.16 (WiMAX), ultra wideband (UWB), infrared (IR) protocols, near field communication (NFC) protocols, Wibree, Bluetooth protocols, wireless universal serial bus (USB) protocols, and/or any other wireless protocol.

Although not shown, the carrier computing entity 100 may include or be in communication with one or more input elements, such as a keyboard input, a mouse input, a touch screen/display input, motion input, movement input, audio input, pointing device input, joystick input, keypad input, and/or the like. The carrier computing entity 100 may also include or be in communication with one or more output elements (not shown), such as audio output, video output, screen/display output, motion output, movement output, and/or the like.

As will be appreciated, one or more of the carrier computing entity's 100 components may be located remotely from other carrier computing entity 100 components, such as in a distributed system. Furthermore, one or more of the components may be combined and additional components performing functions described herein may be included in the carrier computing entity 100. Thus, the carrier computing entity 100 can be adapted to accommodate a variety of needs and circumstances. As will be recognized, these architectures and descriptions are provided for exemplary purposes only and are not limiting to the various embodiments.

### 2. Exemplary User Computing Entity

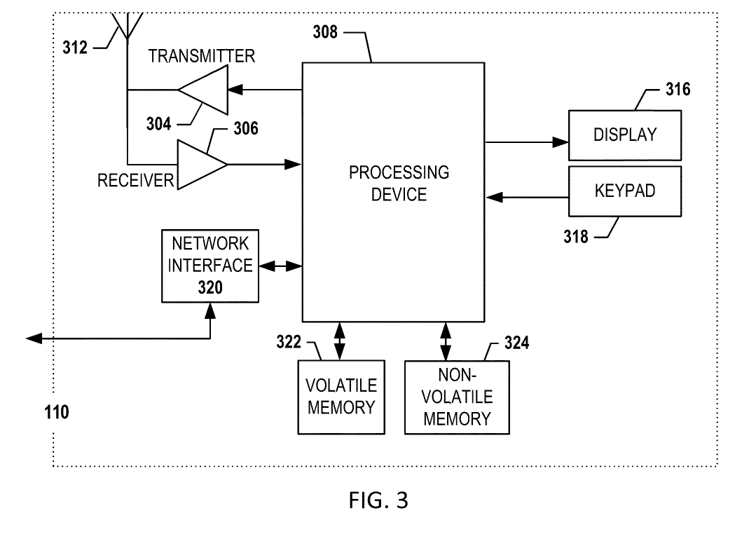

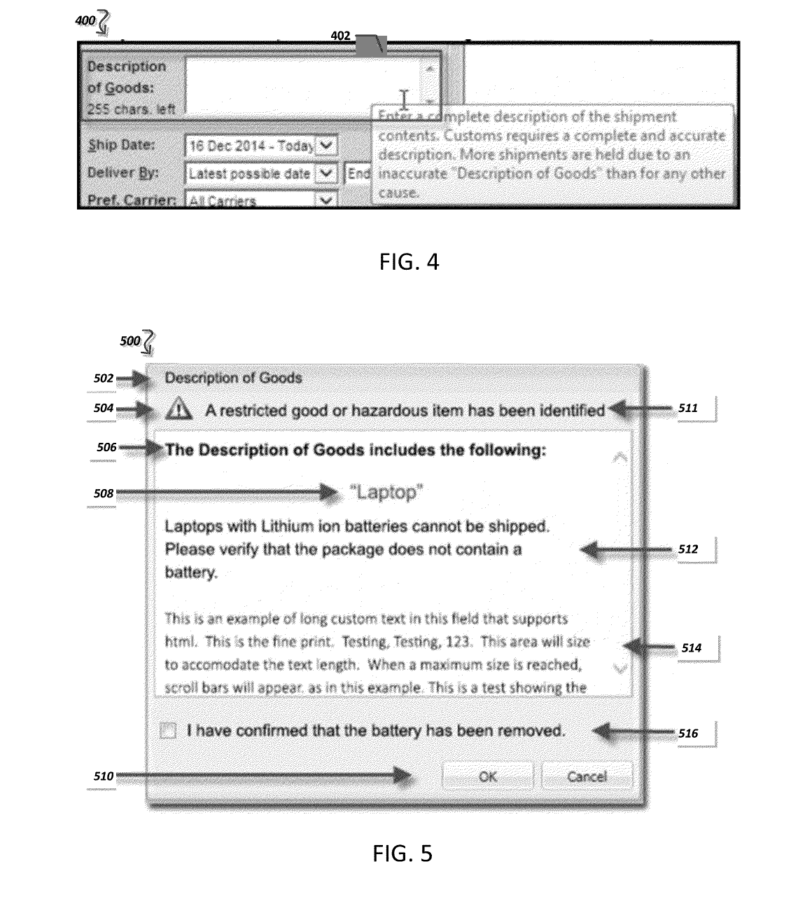

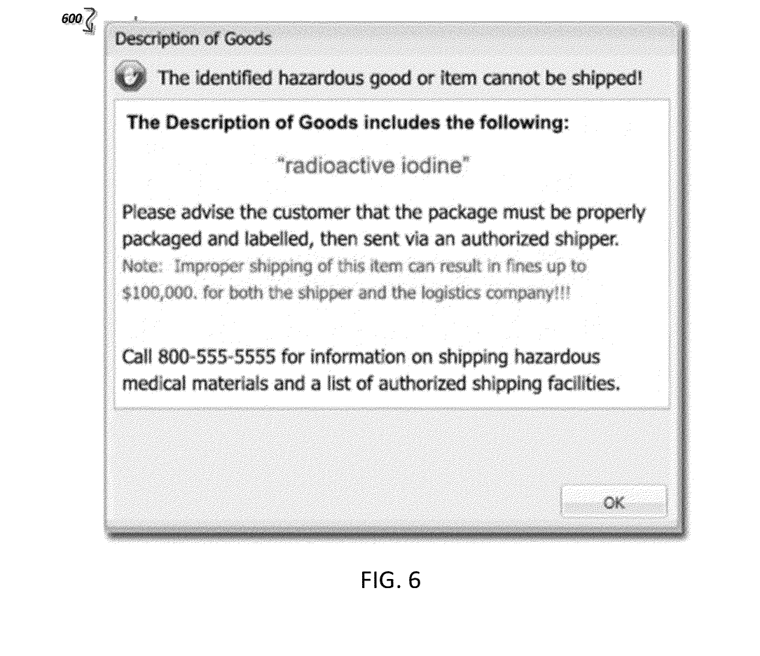

A user may be an individual, a family, a company, an organization, an entity, a department within an organization, a representative of an organization and/or person, and/or the like. In one example, users may be carrier personnel, consignors/shippers, consignees/recipients, and/or the like. For instance, a user may operate a user computing entity 110 that includes one or more components that are functionally similar to those of the carrier computing entity 100. FIG. 3 provides an illustrative schematic representative of a user computing entity 110 that can be used in conjunction with embodiments of the present invention. In general, the terms device, system, computing entity, entity, and/or similar words used herein interchangeably may refer to, for example, one or more computers, computing entities, desktops, mobile phones, tablets, phablets, notebooks, laptops, distributed systems, gaming consoles (e.g., Xbox, Play Station, Wii), watches, glasses, key fobs, radio frequency identification (RFID) tags, ear pieces, scanners, cameras, wristbands, kiosks, input terminals, servers or server networks, blades, gateways, switches, processing devices, processing entities, set-top boxes, relays, routers, network access points, base stations, the like, and/or any combination of devices or entities adapted to perform the functions, operations, and/or processes described herein. User computing entities 110 can be operated by various parties. As shown in FIG. 3, the user computing entity 110 can include an antenna 312, a transmitter 304 (e.g., radio), a receiver 306 (e.g., radio), and a processing element 308 (e.g., CPLDs, microprocessors, multi-core processors, coprocessing entities, ASIPs, microcontrollers, and/or controllers) that provides signals to and receives signals from the transmitter 304 and receiver 306, respectively.

The signals provided to and received from the transmitter 304 and the receiver 306, respectively, may include signaling information in accordance with air interface standards of applicable wireless systems. In this regard, the user computing entity 110 may be capable of operating with one or more air interface standards, communication protocols, modulation types, and access types. More particularly, the user computing entity 110 may operate in accordance with any of a number of wireless communication standards and protocols, such as those described above with regard to the carrier computing entity 100. In a particular embodiment, the user computing entity 110 may operate in accordance with multiple wireless communication standards and protocols, such as UMTS, CDMA2000, 1×RTT, WCDMA, TD-SCDMA, LTE, E-UTRAN, EVDO, HSPA, HSDPA, Wi-Fi, Wi-Fi Direct, WiMAX, UWB, IR, NFC, Bluetooth, USB, and/or the like. Similarly, the user computing entity 110 may operate in accordance with multiple wired communication standards and protocols, such as those described above with regard to the carrier computing entity 100 via a network interface 320.

Via these communication standards and protocols, the user computing entity 110 can communicate with various other entities using concepts such as Unstructured Supplementary Service Data (USSD), Short Message Service (SMS), Multimedia Messaging Service (MMS), Dual-Tone Multi-Frequency Signaling (DTMF), and/or Subscriber Identity Module Dialer (SIM dialer). The user computing entity 110 can also download changes, add-ons, and updates, for instance, to its firmware, software (e.g., including executable instructions, applications, program modules), and operating system.

According to one embodiment, the user computing entity 110 may include location determining aspects, devices, modules, functionalities, and/or similar words used herein interchangeably. For example, the user computing entity 110 may include outdoor positioning aspects, such as a location module adapted to acquire, for example, latitude, longitude, altitude, geocode, course, direction, heading, speed, universal time (UTC), date, and/or various other information/data. In one embodiment, the location module can acquire data, sometimes known as ephemeris data, by identifying the number of satellites in view and the relative positions of those satellites. The satellites may be a variety of different satellites, including Low Earth Orbit (LEO) satellite systems, Department of Defense (DOD) satellite systems, the European Union Galileo positioning systems, the Chinese Compass navigation systems, Indian Regional Navigational satellite systems, and/or the like. Alternatively, the location information can be determined by triangulating the user computing entity's 110 position in connection with a variety of other systems, including cellular towers, Wi-Fi access points, and/or the like. Similarly, the user computing entity 110 may include indoor positioning aspects, such as a location module adapted to acquire, for example, latitude, longitude, altitude, geocode, course, direction, heading, speed, time, date, and/or various other information/data. Some of the indoor systems may use various position or location technologies including RFID tags, indoor beacons or transmitters, Wi-Fi access points, cellular towers, nearby computing devices (e.g., smartphones, laptops) and/or the like. For instance, such technologies may include the iBeacons, Gimbal proximity beacons, Bluetooth Low Energy (BLE) transmitters, NFC transmitters, and/or the like. These indoor positioning aspects can be used in a variety of settings to determine the location of someone or something to within inches or centimeters.

The user computing entity 110 may also comprise a user interface (that can include a display 316 coupled to a processing element 308) and/or a user input interface (coupled to a processing element 308). For example, the user interface may be a user application, browser, user interface, and/or similar words used herein interchangeably executing on and/or accessible via the user computing entity 110 to interact with and/or cause display of information from the carrier computing entity 100, as described herein. The user input interface can comprise any of a number of devices or interfaces allowing the user computing entity 110 to receive data, such as a keypad 318 (hard or soft), a touch display, voice/speech or motion interfaces, or other input device. In embodiments including a keypad 318, the keypad 318 can include (or cause display of) the conventional numeric (0-9) and related keys (#, *), and other keys used for operating the user computing entity 110 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The user computing entity 110 can also include volatile storage or memory 322 and/or non-volatile storage or memory 324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, NVRAM, MRAM, RRAM, SONOS, FJG RAM, Millipede memory, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, TTRAM, T-RAM, Z-RAM, RIMM, DIMM, SIMM, VRAM, cache memory, register memory, and/or the like. The volatile and non-volatile storage or memory can store databases, database instances, database management systems, data, applications, programs, program modules, scripts, source code, object code, byte code, compiled code, interpreted code, machine code, executable instructions, and/or the like to implement the functions of the user computing entity 110. As indicated, this may include a user application that is resident on the entity or accessible through a browser or other user interface for communicating with the carrier computing entity 100 and/or various other computing entities.

In another embodiment, the user computing entity 110 may include one or more components or functionality that are the same or similar to those of the carrier computing entity 100, as described in greater detail above. As will be recognized, these architectures and descriptions are provided for exemplary purposes only and are not limiting to the various embodiments.

### III. Exemplary System Operation

As described above, the carrier computing entity 100 and/or user computing entity 110 may be configured for storing technical data associated with an item, providing technical data associated with an good/item to a user, providing tools for a user accessing technical data associated with an good/item and/or aiding in user access of technical data associated with an item. According to various embodiments, the carrier computing entity 100 and/or user computing entity 110 provides and/or aids in the access of technical data in accordance with user instructions and/or input received via the carrier computing entity 100 and/or user computing entity 110 (e.g., via a user interface). The user interface may be accessible from a user computing entity 110 (e.g., in communication with the carrier computing entity 100 via the network 105). For example, in various embodiments, a user may log in to the carrier computing entity 100 from a user computing entity 110 (e.g., by opening a log-in page and entering a user ID and password using display 316 and keypad 318). The carrier computing entity 100 may be configured to recognize any such log-in request, verify that user has permission to access the system (e.g., by confirming the user ID and password are valid), and present/provide the user with a user interface (e.g., displayed on display 316). In other embodiments, user log-in is not required to access the user interface.

### 1. Exemplary User Interface

FIG. 4 depicts an example user interface element 400 of a user interface for facilitating enforcement of shipping rules (including applicable laws, rules, and regulations) for items/contents of packages. As will be recognized and described herein, the user computing entity 110 displaying the user interface may be in communication with the carrier computing entity 100 to cause display of information/data and/or interaction/communication between the entities. As will be recognized, a package may be any tangible and/or physical object. In one embodiment, a package may be one or more parcels, envelopes, bags, containers, loads, crates, goods/items banded together, pallets, drums, and/or similar words used herein interchangeably. Such packages, items, and/or contents may include the ability to communicate (e.g., via a chip (e.g., an integrated circuit chip), RFID, NFC, Bluetooth, Wi-Fi, and any other suitable communication techniques, standards, or protocols) with one another and/or communicate with various computing entities for a variety of purposes. In this regard, in some example embodiments, such packages, items, and/or contents may communicate send “to” address information/data, received “from” address information/data, unique identifier codes, and/or various other information/data. The user interface element 400 shown in FIG. 4 is for receiving shipping information/data as input from a user of a user computing entity 110. In one implementation, a textual data entry user interface element 402 for receiving description of goods/items to be shipped is presented to a user. In some implementations, the user is a shipping customer, such as a consignor/shipper, consignee/recipient (both referred to herein interchangeably as customers). In some implementations, the user is a shipping agent or carrier personnel responsible for overseeing the shipping initiation process. For example, the user may be an agent of the carrier.

In some implementations, the user interface element 402 can receive a configurable number of characters or letters as a description of the goods/items to be transported by the carrier via the package. For example, the user interface element 402 may be configured to receive a maximum of 255 characters or letters. In some implementations, spaces and other characters may not be counted against the number of maximum characters or letters. In some implementations, other shipping information/data is also entered in user interface element 400. For example, the agent may enter a shipping date for the package prepared for shipping. Similarly, the agent may enter a requested delivery date provided by the customer. Other information required for shipping may also be entered using user interface element 400, such as origin, destination, service level (Next Day Air, Overnight, Express, Next Day Air Early AM, Next Day Air Saver, Jetline, Sprintline, Secureline, 2nd Day Air, Priority, 2nd Day Air Early AM, 3 Day Select, Ground, Standard, First Class, Media Mail, SurePost, Freight, and/or the like), consignor, consignee, contents, carrier, and/or the like.

According to the information/data provided as input via the user interface element 400, different responses are provided. In some implementations, the user computing entity 110 (in communication with the carrier computing entity 110) can generate and provide different responses for display to the user. In some implementations, the carrier computing entity (and/or various other computing entities) may generate and provide the different responses to a consumer device for display. In some implementations, the provided responses are instructions to the user. For example, a response may instruct the agent to perform one or more actions prior to shipping the item. For example, the response may be instructions to the agent to verify that batteries have been removed when a laptop is being shipped. FIG. 5 is a depiction of an example user interface element for facilitating enforcement of shipping rules. In particular, FIG. 5 is an example user interface element for providing a response to provided shipping information/data. In some implementations, user interface element 500 is generated, in real-time, in response to the provided shipping information/data. For example, the user interface element 500 may be generated in real-time by an appropriate computing entity (e.g., a user computing entity, a carrier computing entity).

User interface element 502 specifies a title for the response displayed via user interface element 500. The title identifies a subject to which the response is directed. For example, the title “Description of Goods” specifies that the response provided by user interface element 500 relates to a received description of goods. An icon 504 and header text 511 may also be presented within user interface element 500. For example, the header text 511 may describe what prompted presentation of user interface element 500. Similarly, icon 504 may be presented to further support header text 511. For example, the header text 511 may be “A restricted good or hazardous good/item has been identified” to indicate that a hazardous good/item was identified within the provided description of goods. A “hazardous” symbol 504 may be presented along with header text 511. Other symbols may be presented along with different header texts. For example, a warning symbol may be presented along with a warning text, such as “Your package may include hazardous materials.”

User interface element 506 may be a body header for a specific type of response. For example, user interface element 506 may specify that the description of goods/items includes an good/item that is not allowed for shipping, or an good/item that requires particular steps be performed prior to the good/item being shipped. User interface element 508 identifies one or more goods/items that triggered the response. For example, a response presented in user interface element 500 may be triggered because the words “laptop” or “propane tank” were identified within the description of goods/items provided via interface element 402. The identified words are then displayed at user interface element 508. User interface element 512 is body text that identifies one or more rules that resulted in the respective response being triggered. For example, the text at user interface element 512 may state that “Laptops with Lithium ion batteries cannot be shipped. Please verify that the package does not contain a battery.” Similarly, the text at user interface element 512 may simply state that “Propane tanks are not allowed for shipping.” User interface element 514 allows users to scroll up and down to view other displayed text.

User interface element 516 provides text and an element for user interaction. For example, user interface element 516 may state “I have confirmed that the battery has been removed.” The user interface element 516 may also provide a user interface element for user interaction allowing users to confirm that the action described in the text has been performed. For example, user interface element 516 may include an interaction element (e.g., check box) that allows the user to confirm that the battery was removed from the laptop. User interface element 500 may include dialogue buttons 510. The dialogue buttons may allow the user to confirm the interaction with element 516. The dialogue buttons may also allow the user to terminate the shipping initiation process. In some implementations, user interaction with one or more dialogue buttons 510 may be disallowed prior to interaction with user interface element 516. For example, if the user did not interact with check box 516 confirming that the battery of the laptop has been removed, the “OK” dialogue button may be greyed out. This prevents users from proceeding with the shipping initiation process without the confirmation that the issues prompting display of the current response via user interface element 500 have been resolved. It is understood that user interface element 500 may generate automatic messages identifying specific issues that require the attention of users to resolve. These steps described above may be performed by any appropriate entity. For example, the steps above may be performed by a user computing entity, a carrier computing entity, or a combination of both entities.

### 2. Exemplary Process for Generating Customized Responses for Enforcement of Shipping Rules

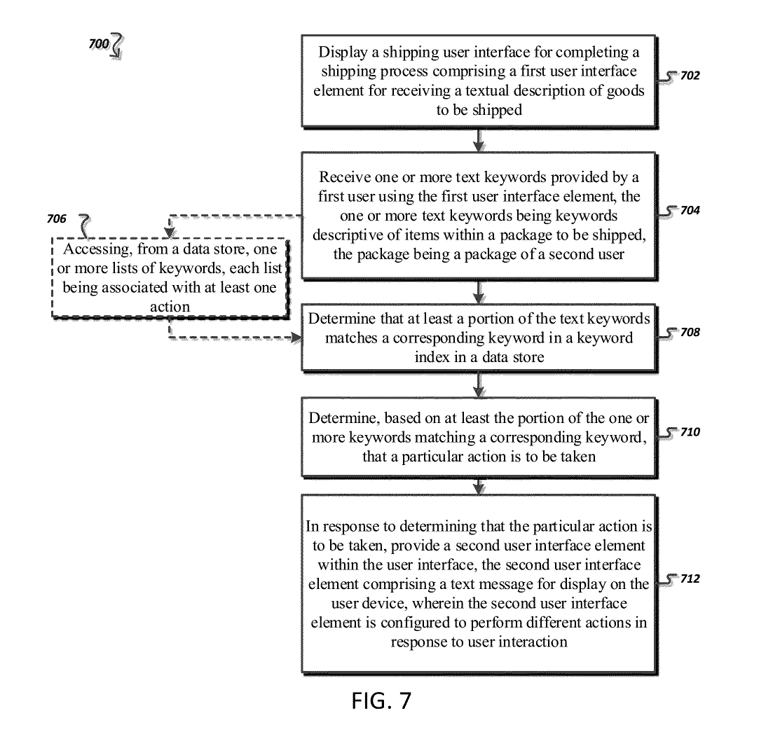

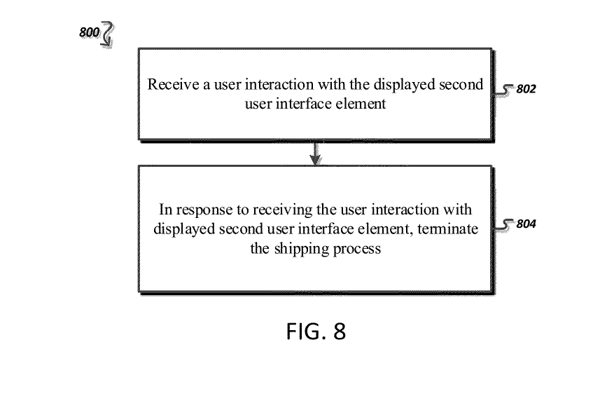

FIG. 7 is a flow chart of an example process for generating a user interface element for providing customized response types wherein the user interface element is configured to perform different actions in response to user interaction. The process 700 can be used to generate user interface elements for providing various types of user responses. The different types of responses are discussed in more detail in the following sections.

The process 700 begins with providing a shipping user interface for completing a shipping initiation process comprising a first user interface element for receiving a textual description of goods/items to be shipped (702). For example, a user interface element similar to user interface 500 of FIG. 5 may be displayed. In turn, the process 700 receives one or more text keywords provided by a first user using the first user interface element, the one or more text keywords being keywords descriptive of goods/items within a package to be shipped, the package being a package of a second user (704) (e.g., a customer such as a consignor or consignee. For example, a user may use one or more input elements, as described above, to input information associated with the goods/items to be shipped. For instance, a user may use a keyboard or other input means to provide textual data describing the goods/items to be shipped. In some implementations, the first user is an agent and the second user is a customer. In other implementations, the first and the second users are a single user (e.g., a customer).

Step 706, shown in phantom, is an optional step that is part of the process 700, in some implementations. The process 700 may continue by accessing, from a data store, one or more lists of keywords, each list being associated with at least one action to provide a filtering functionality. For example, the key word “radioactive iodine” may be stored in association with a block shipping action. Other keywords may be stored in association with different or the same action. For example, the keyword “toxic” may also be associated with a block shipping action. Similarly, the keyword “laptop” may be associated with a provide instructions action. In some implementations, different variants of the word can also be stored. For example, the keyword “laptop” and “laptops” are both stored in association with a provide instructions action.

The process 700 continues with determining whether a portion of the text keywords matches a corresponding keyword in a keyword index in a data store (708). For example, the process 700 may determine that the text keyword “laptop” matches the keyword “laptop” in a keyword index associating keywords with actions. Similarly, the process 700 may determine that the text keyword “laptop” matches a portion of the keyword “laptops” in a keyword index associating keywords with actions. In some implementations, all text keywords and/or combinations of text keywords provided in the description of goods/items section are compared against the keyword index associating keywords with actions. In some implementations, stop words and the like, are removed from the description of goods/items section prior to comparing the remaining text keywords against the keyword index. For example, the words “have” or “has” may be removed from the description of goods/items section prior to the comparison. In some implementations, pre-processing is performed on the text keywords prior to the comparison. Other stop words (e.g., be, because, having, had, further, from for, few, each, down, during doing do, off, and in) may also be removed. For example, a suffix or an ending of a text keyword may be removed prior to the comparison. Similarly, a prefix or a beginning of a text keyword may also be removed prior to the comparison. For example, the letter “s” may be removed from the text keyword “laptops” (laptop” after removal) prior to the comparison. Similarly, the letter “y” may be removed from the text keyword “salty” (salt” after removal) prior to the comparison. Other pre-processing and post-processing techniques may also be used to prepare the text keywords for comparison.

The process 700 then determines, based on at least the portion of the one or more keywords matching a corresponding keyword, that a particular action is to be taken (710). For example, the process 700 may determine that based on a portion of the text keyword “laptops” matching the keyword “laptop” from the index that a provide instructions action is to be taken. The action may be, as described above, instructions to remove batteries from the laptop prior to shipping a package containing the laptop. In some implementations, the process 700 may determine, based on at least the portion of the one or more keywords matching a corresponding keyword, that multiple actions are to be taken. For example, the process 700 may determine that based on text keyword “air bag” matching the text keyword “air bag” from the index that (1) shipping is to be blocked and (2) and a provide warning action is to be taken. In some implementations, the carrier computing entity 100 may block the shipping and provide a warning message to a consumer device 110 for display. In some implementations, the process 700 may determine that shipping is to be blocked based on keyword matching and the shipping destination. For example, the process 700 may determine that based on a portion of the text keyword “banknote” matching a portion of the text keyword “banknotes” from the index that shipping is to be blocked if the shipping address is within the country of France. For example, the process 700 may block the shipping if the shipping address is in Paris, France. On the other hand, the process 700 may allow the shipping if the shipping address is in Rome, Italy. Actions associated with each word from a keyword list or index, can be defined and maintained by the carrier. The actions may be customized according to the shipping rules and regulations. Table A below shows an exemplary keyword index or a keyword list associating one or more actions with keywords.

TABLE A

| Keyword | Action(s) |
|---|---|
| Camping Equipment | Provide a warning specifying that the user |
| | package may include specific goods/items that |
| | are deemed hazardous. |
| Radioactive Iodine | Block Shipping. |
| | Provide a warning specifying that the user |
| | package includes specific goods/items |
| | (Radioactive Iodine) that are deemed |
| | hazardous. |
| Laptop | Provide a warning specifying that laptop |
| | batteries must be removed from laptops prior |
| | to shipping. |
| | Block shipping. |
| | Provide a confirmation element for |
| | confirmation that the laptop batteries were |
| | removed, wherein interaction with the |
| | confirmation element causes allowance of |
| | shipping. |
| Explosive | Block shipping |
| | Inform the authorities |
| Air Bag | Block shipping. |
| | Provide a warning specifying that the user |
| | package includes specific goods/items (Air |
| | Bag) that are deemed hazardous. |
| Fruit and/or Vegetable | Block international shipping only |
| Banknote | Block shipping to France only |
| Card deck | Provide a confirmation element for specifying |
| | whether the card deck is complete. |
| | Block shipping to Germany only if deck is |
| | incomplete |

Finally, in response to determining that the particular action is to be taken, the process 700 provides a second user interface element within the user interface, the second user interface element comprising a message, notification, alert, and/or similar words used herein interchangeably to user computing entity 110, wherein the second user interface element is configured to perform different actions in response to user interaction (712). For example, the process 700 may provide a use interface element similar to the user interface element 500 of FIG. 5, described above. In some implementations, interaction with the user interface element may terminate the shipping initiation process. In some implementations, interaction with the user interface element may complete the shipping initiation process. The steps of process 700 may performed by an appropriate computing entity (e.g., a user computing entity, a carrier computing entity, and/or a combination of both entities).

In some implementations, receiving alterations of information/data at user interface element 400, during the process 700, restarts the process 700. For example, in response to receiving input altering the description of goods/items at user interface element 400, the process 700 may compare text keywords from the altered description of goods/items to the keyword index associating keywords with actions. In some implementations, every time the description of goods/items text is altered, a new comparison between the altered text and the keyword index may be performed.

In some implementations, completion of information/data entry using user interface element 400 is based on a timer. For example, users may be allocated a threshold amount of time to complete the information/data entry process. If the threshold amount of time expires, the shipping initiation process may be terminated. For example, users may be allocated a 2, 3, 5, or 10 minute window to complete the information/data entry process. In response to expiration of the configurable time window, the shipping initiation process may be terminated by an appropriate computing entity (e.g., carrier computing entity 100, user computing entity 110, and/or the like). In some implementations, the user interface element 400 is cleared from any input text in response to the expiration of the configurable time window.

In some implementations, other actions associated with keywords in the keyword index may be also be automatically facilitated by the user interface. For example, a price or a price category may be determined for shipping based on the description of goods/items text keyword matching keywords from an index associating prices with keywords. For example, in response to determining that the goods/items to be shipped include goods/items that are associated with being fragile, a specific tier of shipping prices may be applied to the package. Similarly, insurance may be automatically applied to a package based on the description of goods/items text keywords matching keywords from a keyword index specifying insurance requirements association with keywords. In some implementations, the insurance may be optionally offered via a user interface element. In other implementations, the insurance is automatically applied. In some implementations, the user interface described above is integrated with other shipping systems. For example, the user interface may be integrated with shipping security devices (e.g., metal detectors, Geiger counters, X-Ray machines). In some implementations, goods/items are identified and deemed hazardous in package based on a combination of keyword matching and security devices.

### 3. Exemplary Response Types

As described above different types of response are associated with different text keywords.

A. First Response Type

Some goods/items or materials are not allowed for shipping by some or any carriers. For example, “radioactive iodine” may not be allowed for shipping by a carrier utilizing the described user interface. In some embodiments, in response to completion of process 700, a customized user interface element is displayed. For example, the process 700 may determine that “radioactive iodine” is an item/good included in a package to be shipped. In some implementations, the user may be provided with a user interface element 600 as shown in FIG. 6, in response to the determination. FIG. 6 depicts a user interface element for displaying a first type of response. In some implementations, the user interface element 600 may state that “radioactive iodine” is not allowed for shipping. In some implementations, the user interface element may display a symbol or other indication indicating that the package includes a good/item not allowed for shipping. The particular good/item may be identified within the user interface element 600. In some implementations, a note corresponding to the applicable laws, rules, and/or regulations related to the identified good/item may be displayed via the interface. The interface may also cause display of the associated fine/penalty for violating the same. Also, contact information for obtaining additional information regarding the shipping of such goods/items may be displayed.

In some implementations, the user is provided with an interaction element within the second user interface element. For example, a radio button labeled “OK” may be displayed within the second user interface element. The process 800 is an exemplary process for performing actions in response to user interactions with a second user interface element displaying a first type of response. In some implementations, the first type of response is a block shipping response. The process 800 begins with receiving a user interaction with the displayed second user interface element (802). For example, the user may click/select/check the radio button “OK” of user interface element 600 of FIG. 6. In response to receiving the user interaction with the displayed second user interface element, the process 800 terminates the shipping initiation process (804). For example, the user interface element may be minimized or closed in response to user interaction with the “OK” radio button. The shipping initiation process initiated at step 702 of process 700 is then terminated and the package is not accepted from the shipper/consignor. In some implementations, the user computing entity 110 (in communication with the carrier computing entity 110) can generate and provide the responses and perform steps similar to the steps described above. In some implementations, the response is generated by the carrier computing entity 110 and transferred to the user computing entity 110 for display. In other implementations, the steps described above are performed by a combination of multiple entities (e.g., a user computing entity, and/or a carrier computing entity).

B. Second Response Type

FIG. 9A depicts an exemplary user interface element for displaying a second type of response. In some implementations, some goods/items require that particular steps are performed prior to the shipping of such items. For example, a carrier may require removal of Lithium ion batteries from laptops prior to shipping of the laptops.

In some implementations, in response to completion of process 700, a customized user interface element is displayed. For example, the process 700 may determine that a “laptop” is an item included in a package to be shipped. In some implementations, the user may be provided with a user interface element 900a as shown in FIG. 9A, in response to the determination. In some implementations, the user interface element may state that a “laptop” is not allowed for shipping prior to removal of the laptop's Lithium ion batteries. In some implementations, the user interface element may display a symbol indicating that the additional steps must be completed prior to shipping of the package. The particular steps and associated good/item may be identified within the user interface element. In some implementations, a note corresponding to the applicable laws, rules, and/or regulations related to the identified good/item may be displayed. The rules and regulations may specify an associated fine. Also, contact information for obtaining additional information regarding the shipping may be displayed.

In some implementations, the user interface element 900 includes a confirmation element for the user to indicate that the additional steps have been performed. For example, the confirmation element may be a check box as shown in FIG. 9A. In some implementations, the confirmation element is a radio button. In some implementations, the user is not able to proceed with the shipping initiation process until an interaction with the confirmation element is received. For example, an “OK” radio button for proceeding with the shipping initiation process may not be available for interaction (greyed out) prior to receiving an interaction with the confirmation element. In some implementations, the user can terminate the shipping initiation process by clicking a “Cancel” radio button. As can be seen in FIG. 9B, the “OK” radio button for proceeding with the shipping becomes available for interaction in response to receiving an interaction with the confirmation element.

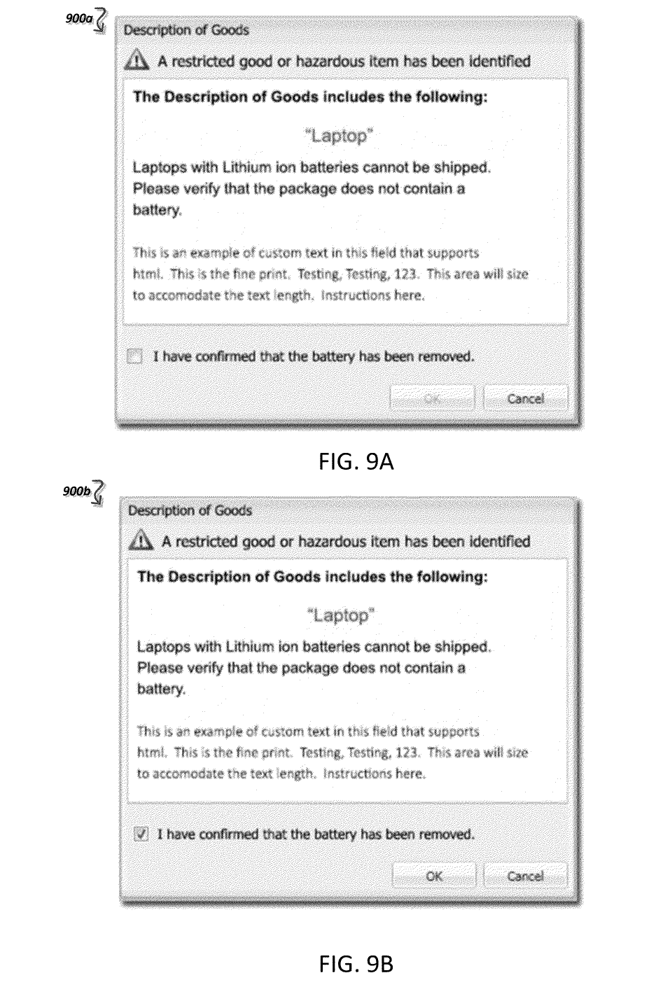

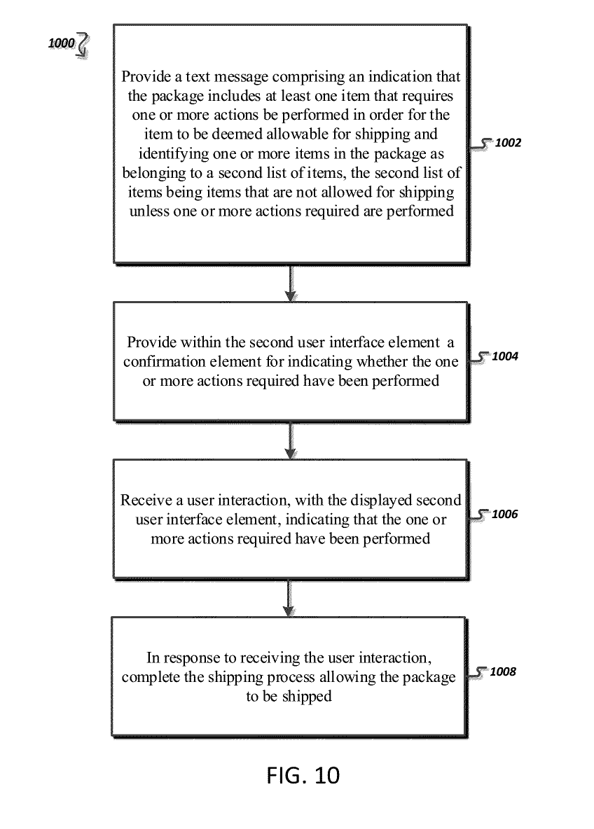

FIG. 10 is a flow chart of an exemplary process 1000 for performing actions in response to user interactions with a second user interface element displaying a second type of response. The process 1000 begins with providing a text message comprising an indication that the package of the second user includes at least one good/item that requires one or more actions be performed in order for the good/item to be deemed allowable for shipping and identifying one or more goods/items in the package as belonging to a second list of items, the second list of goods/items being goods/items that are not allowed for shipping unless one or more actions required are performed (1002). For example, the process 1000 may determine that the package of the second user includes a “laptop” in response to a text keyword for the description of goods/items matching a keyword associated with the second type of response. In some implementations, the process 1000 accesses information associated with the keyword “laptop.” The process 1000 then accesses the steps that need to be performed prior to shipping of a laptop.

The process 1000 continues with providing within the second user interface element a confirmation element for indicating whether the one or more actions required have been performed (1004). For example, the checkbox of FIGS. 9A and 9B may be presented within the second user interface element. In some implementations, the option to proceed with the shipping initiation process is blocked prior to user interaction with the checkbox. In turn, the process 1000 receives a user interaction, with the displayed second user interface element, indicating that the one or more actions required have been performed (1008). In some implementations, the user is allowed to proceed with the shipping initiation process after interaction with the confirmation element.

Finally, the process 1000 completes the shipping initiation process allowing the package to be shipped, in response to receiving the user interaction. For example, in response to interaction with the check box, the process 1000 may complete the shipping initiation process allowing the package containing the laptop to be shipped. In some implementations, a second user interaction is required to complete the shipping initiation process and allow the package to be shipped. In some implementations, the second user interaction is with an interaction element different from the first interaction element. As described above, these steps may be performed by one or more suitable computing entity (e.g., a user computing entity, a carrier computing entity).

C. Third Response Type

FIG. 11 depicts an exemplary user interface element for displaying a second type of response. In some implementations, some text keywords describing goods/items to be shipped may be stored in association with a classification that indicates that the package to be shipped may or may not include hazardous goods/items that are not allowed for shipping. For example, the keyword “camping equipment” may be used to describe content of a package. In some implementations, the carrier may require the user to verify that the package containing “camping equipment” does not include goods/items that are not allowed for shipping.

In some implementations, in response to completion of process 700, a customized user interface element is displayed. For example, the process 700 may determine that “camping equipment” is included in a package to be shipped. In some implementations, the user may be provided with a user interface element 1100 as shown in FIG. 11, in response to the determination. In some implementations, the user interface element may state that “camping equipment” may include goods/items that are not allowed for shipping. For example, the message may state that the description of goods/items includes “camping equipment,” and that “camping equipment may include goods/items such as propane tanks, hurricane lamps, and other potentially hazardous or flammable items.” In some implementations, the user interface element may display a symbol indicating that hazardous goods/items may be included in the package. In some implementations, the user interface elements may display instructions to the user. For example, the user interface element may display instructions to the user stating that the user must verify that the package does not include “propane tanks” or “hurricane lamps.” In some implementations, a note corresponding to the applicable laws, rules, and/or regulations related to the identified good/item may be displayed. The rules and regulations may specify an associated fine. Also, contact information for obtaining additional information regarding the shipping may be displayed.

In some implementations, the user interface element 1100 includes an element for the user to dismiss the instructions. For example, the user interface element 1100 may include an “OK” button that allows the user to complete the shipping initiation process. In some implementations, the user interface element 1100 may include a shipping termination element. For example, the user interface element 1100 may include a “Cancel” button for terminating the shipping initiation process. In some implementations, a confirmation element for the user to indicate that the presented instructions have been followed. For example, the confirmation element may be a check box as shown or a radio button. In some implementations, the user is not able to proceed with the shipping initiation process until an interaction with the confirmation element is received. For example, an “OK” radio button for proceeding with the shipping initiation process may not be available for interaction (greyed out) prior to receiving an interaction with the confirmation element. In some implementations, the user can terminate the shipping initiation process by clicking a “Cancel” radio button.

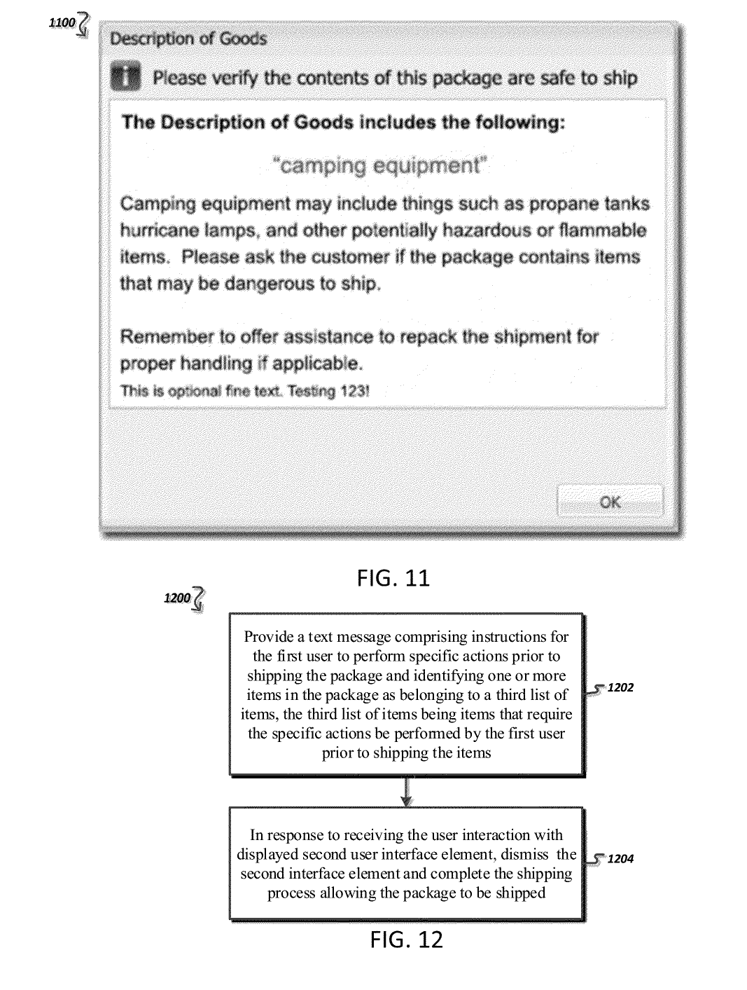

FIG. 12 is a flow chart of an exemplary process 1200 for performing actions in response to user interactions with a second user interface element displaying a third type of response. The process 1200 begins with providing a text message comprising instructions for the first user to perform specific actions prior to shipping the package and identifying one or more goods/items in the package as belonging to a third list of items, the third list of goods/items being goods/items that require the specific actions be performed by the first user prior to shipping the goods/items (1202). For example, the process 1200 may determine that the package to be shipped potentially includes one or more hazardous items. The process 1200 may identify the goods/items that may potentially be in the package. For example, in response to determining that the description of goods/items includes “camping equipment,” the process 1200 may determine a list of goods/items that may be classified as “camping equipment” that are not allowed for shipping. The user interface element 1200 may provide instructions to the user indicating that the user must check the package to determine whether it includes “propane tanks” or “hurricane lamps.” The list of potential hazardous goods/items that may be classified as “camping equipment” may be stored in association with the keyword “camping equipment.” In some implementations, the process 1200 fetches, from a data store, a list of potential hazardous goods/items associated with a keyword that is determined to be in the description of goods.

The process 1200 continues with dismissing the second user interface element and completing shipping initiation process allowing the package to be shipped, in response to receiving the user interaction with displayed second user interface elements (1204). For example, in response to interaction with an “OK” radio button, the process 1200 may complete the shipping initiation process allowing the package containing the laptop to be shipped. In some implementations, a second user interaction is required to complete the shipping initiation process and allow the package to be shipped. In some implementations, the second user interaction is with an interaction element different from the first interaction element. As described above, these steps may be performed by one or more suitable computing entity (e.g., a user computing entity, a carrier computing entity).

D. Fourth Response Type

FIG. 13 depicts an exemplary user interface element for displaying a fourth type of response. In some implementations, the text keywords describing goods/items to be shipped may not have any matches within the keyword index. For example, the keyword “garments” may be used to describe contents of a package. In some implementations, the carrier may require the user to verify that the package does not include any goods/items that are not allowed for shipping. In some implementations, instructions for the verification are displayed at user interface element 1300. In some implementations, the verification instructions are based on broad and general terms. For example, the instructions may specify that the user must verify that the package does not include “liquids, flammable items, perishables, or other illegal or hazardous items.”

In some implementations, in response to completion of process 700, a customized user interface element is displayed. For example, the process 700 may determine that there are no matches between text keywords from the description of goods/items and the keyword index. In some implementations, the user may be provided with a user interface element 1300 as shown in FIG. 13, in response to the determination. In some implementations, the user interface element may provide instructions for the user to verify that certain goods/items or types of goods/items are not included in the package to be shipped. For example, the message may state “please ask the customer if the shipment contains any of the following: liquids, flammable items, perishables, and other illegal or hazardous items.” In some implementations, the user interface element may display a symbol indicating that instructions are provided to the user. In some implementations, a note corresponding to the applicable laws, rules, and/or regulations related to the identified good/item may be displayed. The rules and regulations may specify an associated fine. Also, contact information for obtaining additional information regarding the shipping may be displayed.

In some implementations, the user interface element 1300 includes an element for the user to dismiss the instructions. For example, the user interface element 1300 may include an “OK” button that allows the user to complete the shipping initiation process. In some implementations, the user interface element 1300 may include a shipping termination element. For example, the user interface element 1300 may include a “Cancel” button for terminating the shipping initiation process. In some implementations, a confirmation element for the user to indicate that the presented instructions have been followed. For example, the confirmation element may be a check box or a radio button. In some implementations, the user is not able to proceed with the shipping initiation process until an interaction with the confirmation element is received.

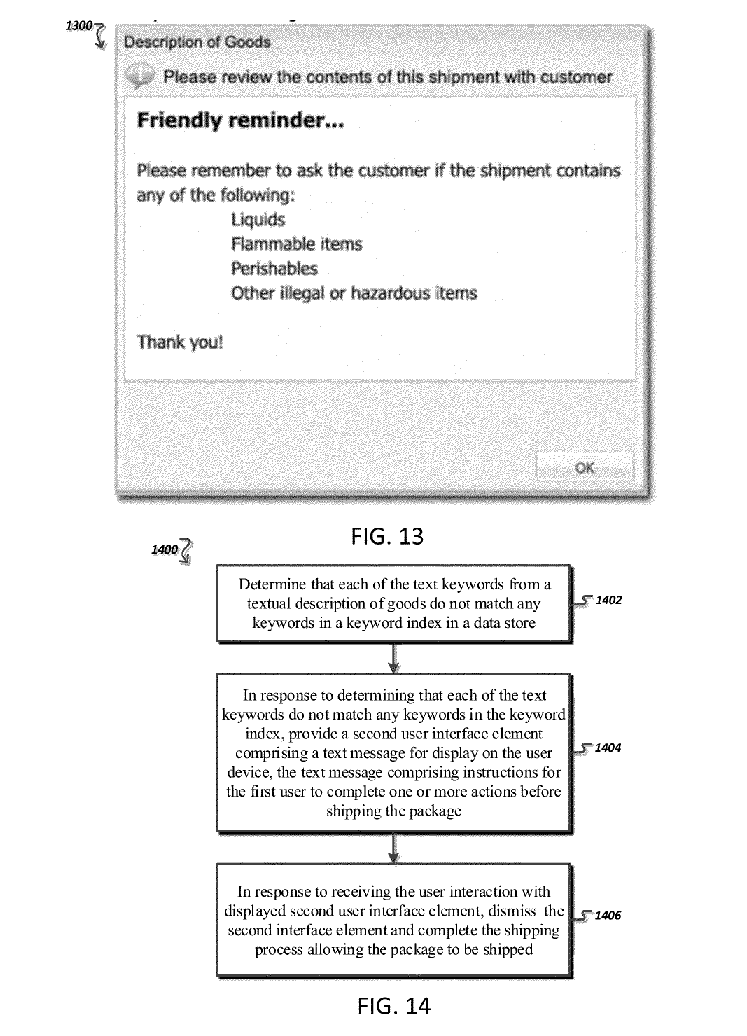

FIG. 14. is a flow chart of an exemplary process 1400 for performing actions in response to user interactions with a second user interface element displaying a fourth type of response. The process 1400 begins with determining that each of the text keywords from a textual description of goods/items does not match any keywords in a keyword index in a data store (1402). For example, text keywords from a user description stating the package includes “toys, garments and shoes,” may not match any of the keywords in the keyword index.

The process 1400 continues with providing a second user interface element comprising a text message for display on the user computing entity 110, the text message comprising instructions for the first user to complete one or more actions before shipping the package, in response to determining that each of the text keywords do not match any keywords in the keyword index (1404). For example, in response to determining that the keywords “toys,” “garments,” and “shoes” do not match any keywords in the keywords index, the process 1400 provides a user interface element, such as 1300, comprising instructions for the user to check the package for liquids, flammable items, perishables or other illegal or hazardous items.

Finally, the process 1400 dismisses the second interface element and completes the shipping initiation process allowing the package to be shipped, in response to receiving the user interaction with displayed second user interface elements (1406). For example, in response to a user interaction with the radio button “OK” of user interface element 1300, the process 1400 may complete the shipping initiation process. Similar to the above, these steps may be performed by one or more suitable computing entity (e.g., a user computing entity, a carrier computing entity).

### 4. Additional Implementation Details

Although an example processing or computing entity/system has been described with reference to FIGS. 1-3, implementations of the subject matter and the functional operations described herein can be implemented in other types of digital electronic circuitry, or in computer software, firmware, or hardware, including the structures disclosed herein and their structural equivalents, or in combinations of one or more of them.

Embodiments of the subject matter and the operations described herein can be implemented in digital electronic circuitry, or in computer software, firmware, or hardware, including the structures disclosed herein and their structural equivalents, or in combinations of one or more of them. Embodiments of the subject matter described herein can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input data and generating output. Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital data communication, e.g., a communication network. Examples of communication networks include a local area network (LAN) and a wide area network (WAN), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

### IV. Conclusion

Many modifications and other embodiments of the inventions set forth herein will come to mind to one skilled in the art to which these inventions pertain, having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation

1. A method comprising:
providing a shipping user interface for display and for completing a shipping initiation process, the shipping user interface comprising a first user interface element for receiving a textual description of a good to be shipped;
receiving one or more keywords via the first user interface element descriptive of the good to be shipped;
determining whether at least a portion of at least one of the one or more keywords matches at least a portion of a corresponding keyword in a keyword list;
responsive to determining that at least a portion of the at least one of the one or more keywords matches at least a portion of a corresponding keyword in the keyword list, identifying an action to be taken for the at least one of the one or more keywords; and
responsive to identifying the action to be taken for the at least one of the one or more keywords, providing a second user interface element within the user interface, the second user interface element being associated with the action to be taken.

2. The method of claim 1, further comprising receiving, from a data store, one or more lists of keywords, each list being associated with at least one action.

3. The method of claim 1, wherein the action comprise blocking the good from being shipped.

4. The method of claim 3, wherein the second user interface element comprises an indication that the good is not allowed to be shipped.

5. The method of claim 4, further comprising:
receiving a user interaction with the second user interface element; and
responsive to receiving the user interaction, terminating the shipping initiation process.

6. The method of claim 1, wherein the action comprise potentially blocking the good from being shipped.

7. The method of claim 6, wherein the second user interface element (a) comprises an indication that the good requires one or more actions be performed for the good to be deemed allowable for shipping and (b) identifies the good requiring the one or more actions to be performed.

8. The method of claim 7, further comprising providing within the second user interface element a confirmation element for indicating that the one or more actions have been performed for the good.

9. The method of claim 1, wherein the second user interface element comprises instructions perform specific actions prior to shipping the good.

10. A system, comprising:
a data processing apparatus; and
a computer memory apparatus in data communication with the data processing apparatus and storing instructions executable by the data processing apparatus and that upon such execution cause the data processing apparatus to perform operations comprising:
providing a shipping user interface for display and for completing a shipping initiation process, the shipping user interface comprising a first user interface element for receiving a textual description of a good to be shipped;
receiving one or more keywords via the first user interface element descriptive of the good to be shipped;
determining whether at least a portion of at least one of the one or more keywords matches at least a portion of a corresponding keyword in a keyword list;
responsive to determining that at least a portion of the at least one of the one or more keywords matches at least a portion of a corresponding keyword in the keyword list, identifying an action to be taken for the at least one of the one or more keywords; and
responsive to identifying the action to be taken for the at least one of the one or more keywords, providing a second user interface element within the user interface, the second user interface element being associated with the action to be taken.

11. The system of claim 10, further comprising receiving, from a data store, one or more lists of keywords, each list being associated with at least one action.

12. The system of claim 10, wherein the action comprise blocking the good from being shipped.

13. The system of claim 12, wherein the second user interface element comprises an indication that the good is not allowed to be shipped.

14. The system of claim 13, wherein the operations further comprise:
receiving a user interaction with the second user interface element; and
responsive to receiving the user interaction, terminating the shipping initiation process.

15. The system of claim 10, wherein the action comprise potentially blocking the good from being shipped.

16. The system of claim 5, wherein the second user interface element (a) comprises an indication that the good requires one or more actions be performed for the good to be deemed allowable for shipping and (b) identifies the good requiring the one or more actions to be performed.

17. The system of claim 16, further comprising providing within the second user interface element a confirmation element for indicating that the one or more actions have been performed for the good.

18. The system of claim 10, wherein the second user interface element comprises instructions perform specific actions prior to shipping the good.

19. A computer program product comprising at least one non-transitory computer-readable storage medium having computer-readable program code portions stored therein, the computer-readable program code portions comprising:
an executable portion configured to provide a shipping user interface for display and for completing a shipping initiation process, the shipping user interface comprising a first user interface element for receiving a textual description of a good to be shipped;
an executable portion configured to receive one or more keywords via the first user interface element descriptive of the good to be shipped;
an executable portion configured to determine whether at least a portion of at least one of the one or more keywords matches at least a portion of a corresponding keyword in a keyword list;
an executable portion configured to, responsive to determining that at least a portion of the at least one of the one or more keywords matches at least a portion of a corresponding keyword in the keyword list, identify an action to be taken for the at least one of the one or more keywords; and
an executable portion configured to, responsive to identifying the action to be taken for the at least one of the one or more keywords, provide a second user interface element within the user interface, the second user interface element being associated with the action to be taken.

20. The computer program product of claim 19, wherein the computer-readable program code portions further comprise an executable portion configured to receive, from a data store, one or more lists of keywords, each list being associated with at least one action.

21. The computer program product of claim 19, wherein the action comprise blocking the good from being shipped.

22. The computer program product of claim 21, wherein the second user interface element comprises an indication that the good is not allowed to be shipped.

23. The computer program product of claim 22, wherein the computer-readable program code portions further comprise:
an executable portion configured to, receive a user interaction with the second user interface element; and
an executable portion configured to, responsive to receiving the user interaction, terminate the shipping initiation process.

24. The computer program product of claim 19, wherein the action comprise potentially blocking the good from being shipped.

25. The computer program product of claim 24, wherein the second user interface element (a) comprises an indication that the good requires one or more actions be performed for the good to be deemed allowable for shipping and (b) identifies the good requiring the one or more actions to be performed.

26. The computer program product of claim 25, wherein the computer-readable program code portions further comprise, an executable portion configured to provide within the second user interface element a confirmation element for indicating that the one or more actions have been performed for the good.

27. The computer program product of claim 19, wherein the second user interface element comprises instructions perform specific actions prior to shipping the good.
